(19) United States
(12) Patent Application Publication
(10) Pub. No.: US 2010/0269976 A1
(43) Pub. Date: Oct. 28, 2010

(54) PROCESS AND PLANT FOR BUILDING TYRES FOR VEHICLE WHEELS

(75) Inventors: Maurizio Marchini, Milano (IT); Gaetano Lo Presti, Milano (IT); Ezio Musitelli, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: PIRELLI TYRE S.PA., Milano (IT)

(21) Appl. No.: 12/809,987

(22) PCT Filed: Dec. 21, 2007
(86) PCT No.: PCT/IB2007/004066

§ 371 Date: Jun. 21, 2010

(51) Int. Cl. B29D 30/28; B29D 30/70

(52) U.S. Cl. 156/126; 156/421.4

(57) ABSTRACT

A process for building tyres for vehicle wheels wherein each tyre includes a carcass structure and a crown structure, the crown structure including a belt structure including a first radially inner belt layer and at least one second belt layer radially external to the first belt layer, the process including the steps of: a) placing an annular assembly including a first radially inner belt layer and at least one second radially outer belt layer on at least one auxiliary turning up drum; b) defining at least one pair of folding lines in axially opposite positions of the annular assembly by respective abutment devices radially external to the auxiliary turning up drum; c) adjusting the axial position of the folding lines relative to a centre line plane of the auxiliary turning up drum; and d) turning up, at the folding lines, at least a part of end portions of the first belt layer axially protruding relative to the at least one second belt layer on the at least one second belt layer of the annular assembly.

The present invention relates to a process for building tyres for vehicle wheels.

The present invention also relates to an apparatus for building tyres for vehicle wheels and the relevant building plant usable for carrying out the building process mentioned above.

A tyre generally comprises a toroidally ring-shaped carcass including one or more carcass plies, strengthened with reinforcing cords lying in substantially radial planes (a radial plane contains the rotation axis of the tyre). Each carcass ply has its ends integrally associated with at least one metal reinforcing annular structure, known as bead core, constituting the reinforcing at the beads, i.e. at the radially inner ends of the tyre, having the function of enabling the assembling of the tyre with a corresponding mounting rim. Placed crown wise to said carcass is a band of elastomeric material, called tread band, within which, at the end of the moulding and vulcanization steps, a raised pattern is formed for ground contact. A reinforcing structure, generally known as belt structure, is placed between the carcass and the tread band. Such structure usually comprises, in the case of car tyres, at least two radially superposed layers of rubberised fabric provided with reinforcing cords, usually of metal material, placed parallel to each other in each layer and in a crossed relationship with the cords of the adjacent layer, preferably symmetrically placed with respect to the equatorial plane of the tyre. Preferably, the belt structure further comprises at a radially outer position thereof, at least on the ends of the underlying belt layers, also a third layer of textile or metallic cords, circumferentially disposed (at zero degrees).

The belt structure and the tread band together form the so called “crown structure” of the tyre.

Finally, in tyres of the tubeless type, a radially inner layer, called liner, is present which has imperviousness features for ensuring the air-tightness of the tyre itself.

To the aims of the present description and in the following claims, by the term “elastomeric material” it is intended a composition comprising at least one elastomeric polymer and at least one reinforcing filler. Preferably, such composition further comprises additives such as cross-linking and/or plasticizing agents. By virtue of the cross-linking agents, such material may be cross-linked by heating, so as to form the final manufactured article.

EP 0 015 113 A1 describes a machine and a method for folding the circumferential edge portions of a tyre component. The folding machine comprises: an annular deck having a cylindrical support surface for the component and a precisely formed sharply shouldered peripheral deck edge, and a bladder assembly positioned axially and radially inwardly of said deck edge cooperating when inflated with said deck edge to fold the overhanging circumferential edge portion of the component at such deck edge.

JP 57098342 describes the assembly of belt layers of a tyre. The layers are wound on a drum flange and both ends of each layer are folded, moving contrast rollers in contact with the layer surfaces, while chambers expansible to both end surfaces of the drum flange are expanded. The rollers are then separated, the layers are folded towards the drum flange and a roller is applied on the belt layer to squeeze the layer by the entire circumferential extension thereof in a position coinciding with the end of the drum flange, so that the width of the drum flange and that of the belt after the folding step coincide with each other.

In the building of some models of tyres it is preferable that the ends of the layers forming the belt structure are turned up so as to avoid having free ends of the reinforcing cords. In fact, the latter could cause cracks between the belt structure and the carcass structure which would tend to propagate in radial direction, damaging the tyre structure.

Moreover, it is particularly useful to turn up the ends of the belt layers for performance reasons. In fact, it is known that the operation of turning up a belt layer on the layers radially external thereto, imparts greater reactivity and readiness of the tyre on a bend.

However, in order to achieve the above advantages the turning up operation must be carried out in an accurate manner.

The Applicant has found that while machines of the type described in EP 0 015 113 and JP 57098342 are aimed at achieving precise and well defined folding of tyre components, they may not achieve a good folding quality.

Moreover, the folding methods of the type described in EP 0 015 113 and in JP 57098342 do not pursue nor attain high production flexibility and productivity. In fact, in order to meet the current production requirements, it is not sufficient to obtain an accurate turning up of the belt structure, but it is necessary to insert the turning up operation in a context characterised by high daily productivity for tyres dimensionally differing from each other, and by flexibility. More precisely, by flexibility it is meant the possibility of using for each tyre elementary semi-finished products differing by type of elastomeric material or by type of textile or metal reinforcing cord.

The Applicant has therefore perceived that to sequentially build different types of tyres, in particular high performance tyres, with technological requirements very different from each other, keeping a high productivity and improving accuracy and flexibility of the belt layers turning up operations, it is necessary to use a building process through a building plant provided with a dedicated apparatus for turning up the belt layers which should be very flexible from the point of view of the materials used for the tyre being processed.

In particular, the Applicant has noted that if the above folding operation must be carried out between the layers forming the tyre belt structure while building the same, such dedicated apparatus must also be rapid and accurate both in the folding operations and in the inlet/outlet of the components to be folded.

The Applicant has further understood that having a turning up apparatus provided with an apposite turning up drum and abutment devices radially external to said turning up drum and axially adjustable relative thereto, it is possible to obtain very accurate turning up of the belt layers and above all, it is possible to turn up such layers exactly where desired.

Finally, the Applicant has found that placing an annular assembly comprising a plurality of belt layers on an auxiliary drum and defining a pair of folding lines, by actuating at least one axially adjustable abutment devices, the operation for turning up the radially inner belt layer on the radially outermost belt layer takes place rapidly, precisely and independently of the dimensions of the belt structure itself. In this way it is possible to obtain high performance tyres keeping high also productivity and technological flexibility.

More precisely, according to a first aspect thereof, the invention relates to a process for building tyres for vehicle wheels wherein each tyre comprises a carcass structure and a crown structure, said crown structure comprising a belt structure including a first radially inner belt layer and at least one second belt layer radially external to the first belt layer, said process comprising the steps of:
a) placing an annular assembly comprising a first radially inner belt layer and at least one second belt layer radially external to said first belt layer on at least one auxiliary turning up drum;
b) defining at least one pair of folding lines in axially opposite positions of said annular assembly by means of respective abutment devices radially external to said auxiliary turning up drum;
c) adjusting the axial position of said folding lines relative to a centre line plane Y-Y′ of the auxiliary turning up drum;
d) turning up, at said folding lines, at least one part of end portions of said first belt layer axially protruding relative to said at least one second belt layer on said at least one second belt layer of said annular assembly.

The above process therefore overcomes the above problems of making complex components in the process for building a tyre (the belt structure with turned up belt layers) in a context of high productivity even for small production batches and of technological flexibility on each batch produced.

According to a second aspect thereof, the invention relates to an apparatus for building tyres for vehicle wheels, each tyre comprising a carcass structure and a crown structure, said crown structure comprising a belt structure including a first radially inner belt layer and at least one second belt layer radially external to the first belt layer, said apparatus comprising:

at least one auxiliary turning up drum adapted for supporting an annular assembly, comprising a first radially inner belt layer and at least one second belt layer radially external to said first belt layer;

a plurality of abutment devices, radially external to said auxiliary turning up drum adapted for defining at least one pair of folding lines in axially opposite positions of said annular assembly;

wherein said abutment devices are adjustable in axial direction relative to a centre line plane Y-Y′ of the auxiliary turning up drum.

Carrying out the above process, said apparatus achieves the same advantages mentioned above.

The Applicant has further verified that since the building apparatus is provided with abutment devices radially external to the auxiliary drum and axially adjustable, it allows obtaining accurate turning up and thus high performance quality of the final product.

In fact, thanks to the axial adjustment of the abutment devices, the apparatus according to the present invention allows deciding the exact position wherein the ends of the first belt layers should be folded on at least one radially outer layer and thus obtain the desired turning up.

In accordance with a third aspect thereof, the invention relates to a plant for building tyres for vehicle wheels comprising:

at least one carcass structure building line, said carcass structure comprising at least one carcass ply and a pair of annular anchoring structures;

at least one crown structure building line, said crown structure comprising a belt structure and a tread band;

wherein the crown structure building line comprises at least one apparatus for building tyres as described above.

The present invention, in at least one of the above aspects thereof, can exhibit at least one of the following preferred features.

In a particularly preferred embodiment, said process provides that step a) is preceded by a step of:
f) picking up said annular assembly from at least one first building drum.

Providing the transfer of the annular assembly from a building drum to an auxiliary drum and the carrying out of the belt turning up step on such auxiliary drum, said process allows obviating the above disadvantages of low technological flexibility, while keeping a high productivity.

After step d), the process preferably provides a step of:
e) transferring the annular assembly on a second building drum.

In this way, the process is technologically even more flexible and efficient, since it allows choosing the most suitable drum for the type of operations to be performed.

As an alternative, step d) is followed by a step of:
e′) transferring the annular assembly on said first building drum.

This is possible, and in that case advantageous, when the technological requirements are such as to require a building drum of the same type both for pre-turning up and post-turning up operations.

Advantageously, the building process comprises the further step of adjusting the radial position of said abutment devices, relative to said auxiliary turning up drum, preferably according to the thickness and/or the diameter of said annular assembly. This makes the process flexible as the dimensions of the tyre to be produced change.

According to a first embodiment of the process of the invention, the adjustment of the axial position of said folding lines comprises adjusting the axial position of at least one pair of contrast rollers relative to the centre line plane Y-Y′ of the auxiliary turning up drum.

The step d) of turning up is preferably carried out substantially simultaneously to the rotation of the auxiliary turning up drum about the axis of rotation X-X′ thereof.

Preferably, at least one between steps f), a) and e) is carried out by at least one transfer device.

According to a second embodiment of the building process of the invention, the adjustment of the axial position of the folding lines comprises adjusting the axial position of at least one pair of contrast elements of said transfer device relative to the centre line plane Y-Y′ of the auxiliary turning up drum.

Advantageously, the step d) of turning up comprises the step of turning up at least a part of axially opposite end portions of said first radially inner belt layer on said second belt layer and on a third belt layer radially external to said second belt layer.

It is preferable that the building process further comprises the step g) of adjusting the diameter of said auxiliary turning up drum. This increases the process flexibility from the point of view of the dimensions of the tyre to be produced.

Preferably, said step g) is carried out before step a) of placing said annular assembly on at least said auxiliary turning up drum.

The process may further comprise the step g1) of adjusting the width of said auxiliary turning up drum. Within the present context, the term “width of the auxiliary drum” indicates the dimension developing along the axis of rotation X-X′ of the auxiliary drum itself.

Preferably, said step g1) is carried out before step a) of placing said annular assembly on said at least one auxiliary turning up drum.

Preferably, said step g1) is carried out before step e) of transferring the annular assembly on a second building drum.

Preferably, said step g1) is carried out before step e′) of transferring the annular assembly on the first building drum.

According to preferred embodiments, at least one between step a) of placing the annular assembly on at least one auxiliary turning up drum and step e) of transferring the annular assembly on a building drum is followed by a step of shaping the belt structure.

Preferably, at least one between step a) of placing the annular assembly on at least one auxiliary turning up drum and step e′) of transferring the annular assembly on the first building drum is followed by a step of shaping the belt structure.

According to an embodiment of the building process, each folding line is substantially defined at the axial end of the radially outermost belt layer.

As an alternative, each folding line is defined in axially outer position relative to the axial end of the radially outermost belt layer.

According to one embodiment of the process of the invention, the step d) of turning up is substantially carried out simultaneously along the entire circumferential extension of each folding line.

Preferably, said step d) of turning up is carried out by at least one turning up device.

Preferably, said step d) comprises the step of adjusting the axial position of said turning up device relative to said auxiliary turning up drum.

Preferably, said step d) comprises the step of adjusting the radial position of said turning up device relative to said auxiliary turning up drum, preferably according to the thickness and/or the diameter of the annular assembly.

According to a particularly preferred embodiment of the invention, the building apparatus comprises at least one transfer device adapted for transferring said annular assembly from a building drum to said at least one auxiliary turning up drum and vice versa.

The Applicant has verified that since the building apparatus provides an auxiliary drum whereon the turning up operation is carried out which is separate from the building drum, and a transfer device to and from said auxiliary drum, it allows overcoming also the above disadvantages due to an efficient production of tyres dimensionally different from each other and to the technological flexibility required, since it is possible to select time by time the most suitable features of the drums for the type and performance of the tyre to be produced.

Preferably, the abutment devices of the building apparatus are adjustable also in radial direction relative to the auxiliary turning up drum.

Advantageously, said abutment devices comprise at least one pair of contrast rollers.

As an alternative, they comprise at least one pair of contrast elements of said transfer device.

In that case, the transfer device is adjustable in radial direction relative to the auxiliary turning up drum.

Preferably, the transfer device is adjustable in axial direction relative to the centre line plane Y-Y′ of the auxiliary turning up drum.

Even more preferably, the contrast elements of the transfer device are adjustable in axial direction relative to the centre line plane Y-Y′ of the auxiliary turning up drum.

According to preferred embodiments, the auxiliary turning up drum has an adjustable diameter.

Preferably, the auxiliary turning up drum has an adjustable width. In this context, the “width of the auxiliary drum” is intended as defined above.

Preferably, the apparatus further comprises a turning up device which is adjustable in axial direction relative to the auxiliary turning up drum.

Preferably, said turning up device is adjustable in radial direction.

According to one embodiment, said turning up device comprises at least one pair of turning up rollers, each turning up roller being adapted for being rotated about each folding line so as to turn up at least a part of each end portion of said first belt layer on said at least one second belt layer.

It is preferable that each turning up roller comprises a barrel roller driven in rotation by pushing devices.

According to one alternative embodiment, said turning up device comprises at least one pair of pressing elements circumferentially placed at axially opposite parts of the auxiliary turning up drum.

Preferably, each of said pressing elements is radially expansible relative to the axis of rotation X-X′ of the auxiliary drum between a retracted position and an expanded position for turning up at least a part of each end portion of said first belt layer on said at least one second belt layer.

Advantageously, each of said pressing elements comprises a plurality of contact elements, placed along a circumference concentric to the axis of rotation X-X′ of the auxiliary turning up drum, each contact element being telescopically sliding circumferentially relative to the adjacent contact element.

As an alternative, each of said pressing elements comprises a plurality of contact elements, placed along a circumference concentric to the axis of rotation X-X′ of the auxiliary turning up drum, connected by a plurality of elastic devices.

The auxiliary turning up drum advantageously comprises a shaping surface.

Said shaping surface is preferably convex.

According to preferred embodiments, the transfer devices comprise a plurality of sectors.

According to a further embodiment, the first building drum coincides with said second building drum.

Preferably, the auxiliary turning up drum is geometrically different from the first building drum.

Even more preferably, the auxiliary turning up drum is geometrically different from the second building drum.

Further features and advantages of invention will appear more clearly from the following description of some preferred examples of production plants and processes according to the invention, made by way of an indicative non-limiting example with reference to the annexed drawings, wherein:

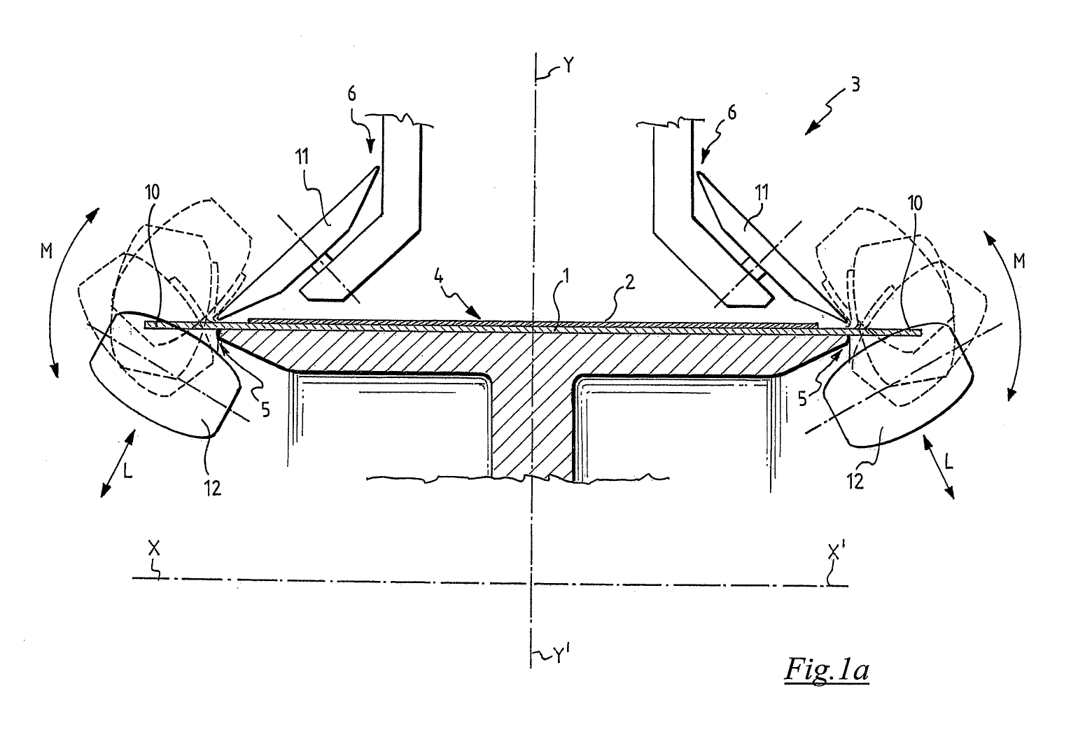

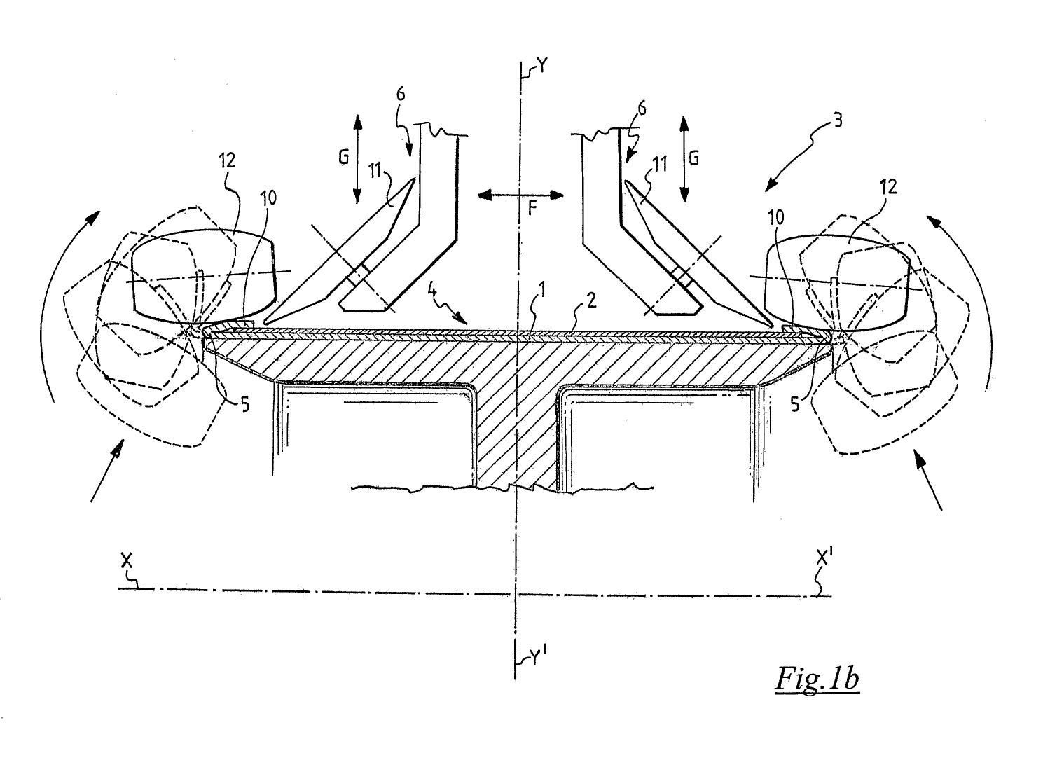

FIGS. 1a and 1b show an axial section view of a part of the tyre building apparatus according to a first embodiment of the invention in two subsequent steps of the building process according to the present invention;

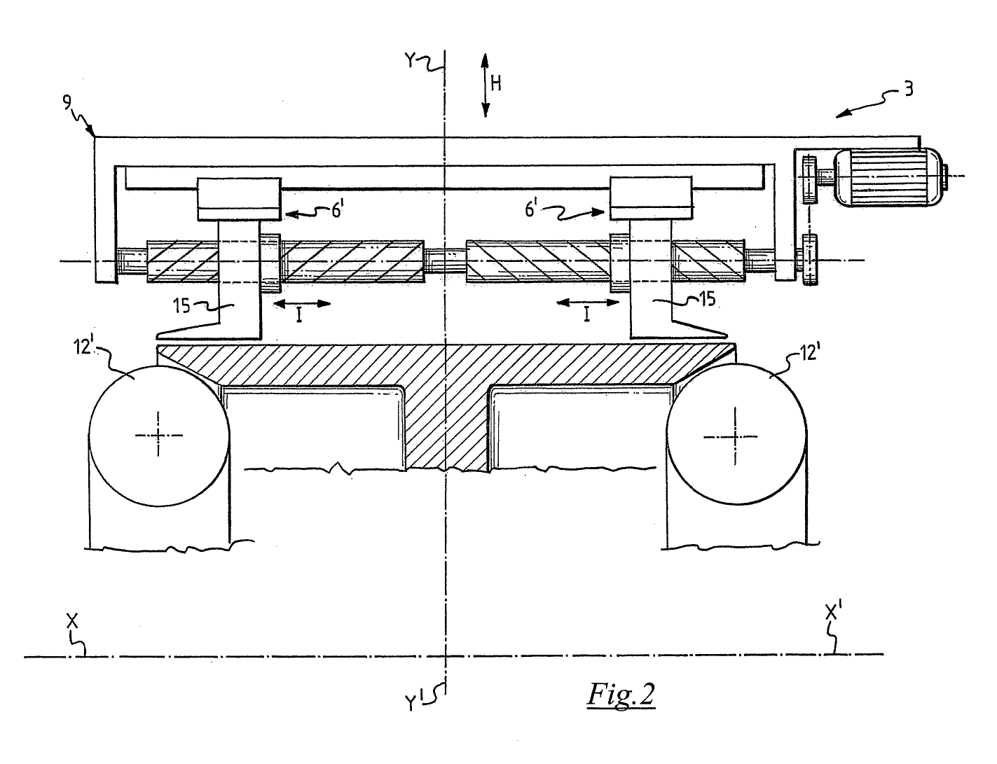

FIG. 2 shows an axial section view of a part of the tyre building apparatus according to a second embodiment of the invention;

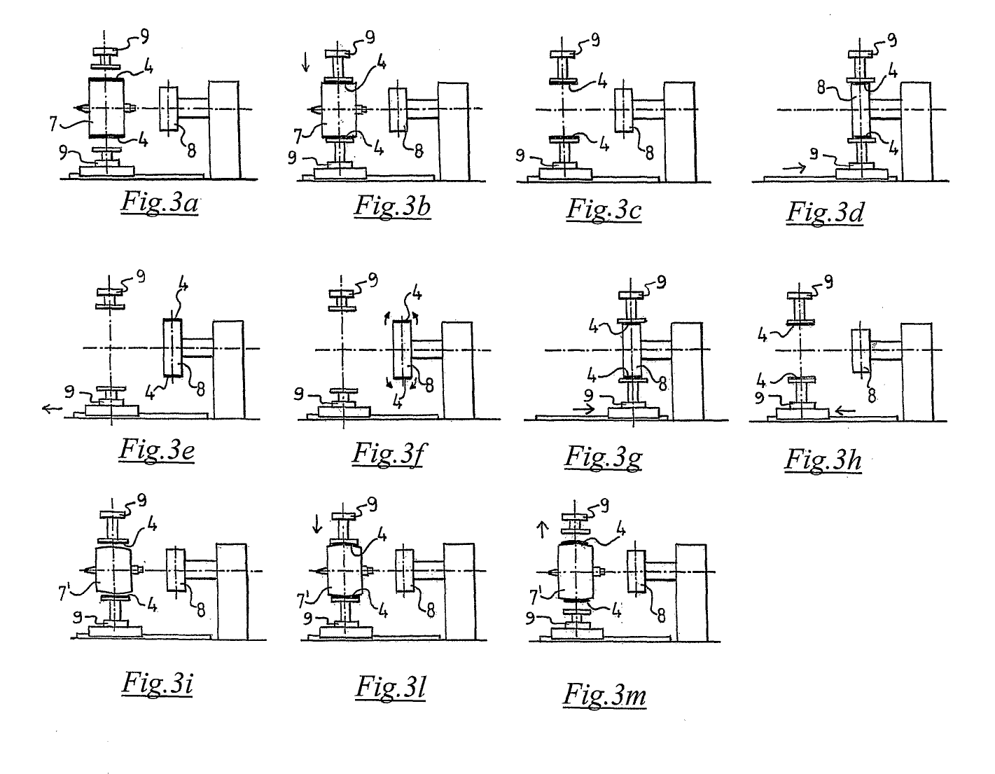

FIGS. 3a-3m schematically show the building apparatus of the invention during the different operating steps of the building process according to one embodiment of the present invention;

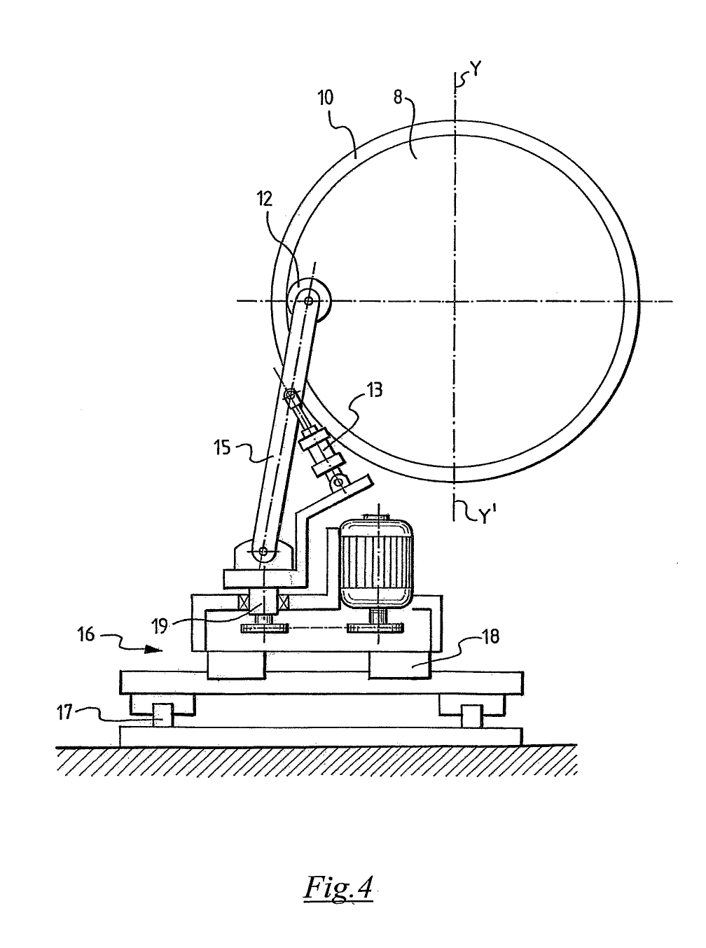

FIG. 4 shows a side view of a turning up device of the building apparatus according to one embodiment of the invention;

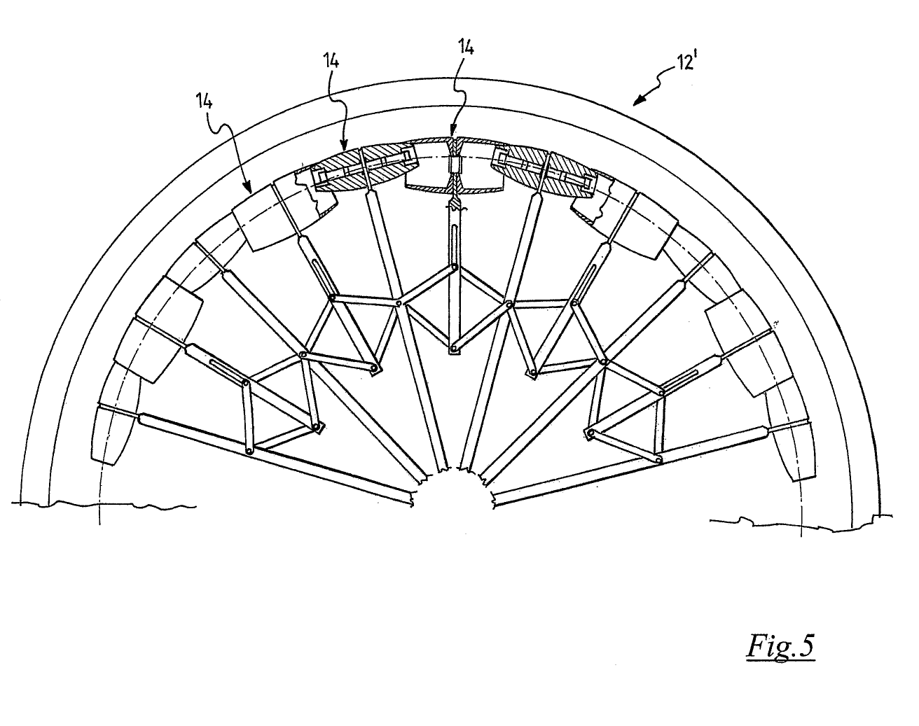

FIG. 5 shows a partial section view of a turning up device of the building apparatus according to an alternative embodiment of the invention; and

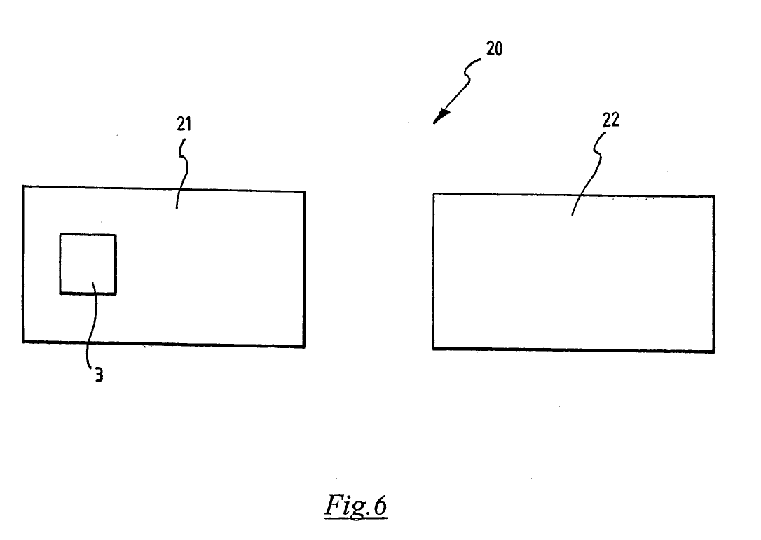

FIG. 6 shows a schematic layout of a plant for building tyres for vehicle wheels wherein the process according to one embodiment of the present invention is carried out.

With reference to FIGS. 1a, 1b and 2, reference numeral 3 globally indicates an apparatus of a building plant 20 for building tyres for vehicle wheels according to the present invention.

Each tyre built in the building plant 20 including apparatus 3 comprises a carcass structure exhibiting at least one carcass ply associated to an annular reinforcing structure and a crown structure comprising at least one belt structure which in turn up comprises a first radially inner belt layer 1 and at least one second belt layer 2 radially external to the first belt layer 1.

Apparatus 3 for building tyres according to the invention comprises at least one auxiliary turning up drum 8 adapted for supporting an annular assembly 4, comprising a first radially inner belt layer 1 and at least one second belt layer 2 radially external to said first belt layer 1.

According to preferred embodiments of the invention, such auxiliary turning up drum 8 is adjustable by diameter and/or height, that is, it is possible to adjust the dimensions thereof both radially and axially relative to the axis of rotation X-X′ thereof.

According to the present invention, apparatus 3 also comprises a plurality of abutment devices 6; 6′ radially external to the auxiliary turning up drum 8. They are adapted for defining at least one pair of folding lines 5 in axially opposite positions of said annular assembly 4, as shown in FIGS. 2a and 1b. Such folding lines 5 define the exact position wherein ends 10 of the first belt layer 1 are turned up on the radially outer belt layer(s).

The abutment devices 6; 6′ according to the present invention are adjustable in axial direction relative to a centre line plane Y-Y′ of the auxiliary turning up drum 8, as shown by arrow F in FIG. 1b.

With particular reference to FIG. 2, and with reference now also to FIGS. 3a-3m, it is shown that apparatus 3, according to such preferred embodiments, comprises at least one transfer device 9. The latter is adapted for transferring the annular assembly 4 from a building drum 7, 7′ to said at least one auxiliary turning up drum 8 and vice versa.

Preferably, the transfer devices 9 comprise a plurality of sectors whose reciprocal position is adjustable according to the requirements.

The abutment devices 6; 6′ are adjustable also in radial direction relative to the auxiliary turning up drum 8, as shown by arrow G in FIG. 1b.

In the first embodiment of the building apparatus 3, shown in FIGS. 1a and 1b, the abutment devices 6 comprise at least one pair of contrast rollers 11.

While in the second embodiment, shown in FIG. 2, such abutment devices 6′ comprise at least one pair of contrast elements 15 of said transfer device 9. That is, the abutment devices 6′ are, in this case, integral with the transfer devices 9.

The latter are adjustable in radial direction relative to the auxiliary turning up drum 8 in both embodiments above. In fact, while this is visible only in the second embodiment (FIG. 2) by means of arrow H, the radial adjustment of the transfer devices 9 is also provided in the first embodiment (FIGS. 1a and 1b), wherein the transfer devices 9 are not shown.

Moreover, in the second embodiment of apparatus 3 of the invention, the contrast elements 15 of the transfer device 9 are adjustable in axial direction relative to the centre line plane Y-Y′ of the auxiliary turning up drum 8, as shown by arrows I of FIG. 2. Such feature may also be provided for the first embodiment.

Apparatus 3 further comprises a turning up device which is preferably adjustable in axial and optionally radial direction relative to the auxiliary turning up drum 8.

According to the first embodiment, said turning up device comprises at least one pair of turning up rollers 12, each being adapted for being rotated about each folding line 5 so as to turn up at least a part of each end portion 10 of said first belt layer 1 on said at least one second belt layer 2.

The operation of the turning up device, according to such first embodiment, is better shown in FIG. 4, which shows a side view from the right (with reference to FIGS. 1a and 1b) of said turning up device in operating condition.

As illustrated in such FIG. 4, each turning up roller 12 comprises a barrel roller driven in rotation by special pushing devices 13. The latter are adapted for driving in rotation the turning up rollers 12 through a bar 15 rigidly connected with said turning up rollers 12 and to an adjustment unit 16.

The adjustment unit 16 comprises devices for adjusting the axial position 17 of the turning up rollers 12, devices for adjusting the radial position 18 of the turning up rollers 12 and devices for adjusting the rotation 19 of the turning up rollers 12.

The pushing devices 13 preferably comprise a pneumatic or hydraulic cylinder.

Such turning up device described with reference to the first embodiment, is also usable in a building apparatus 3 wherein the abutment devices 6′ are integral with the transfer devices 9, that is, in an apparatus 3 of the type described in the second embodiment.

According to the second embodiment, shown in FIG. 2, the turning up device comprises at least one pair of pressing elements 12′ circumferentially arranged at axially opposite parts of the auxiliary turning up drum 8.

Each of said pressing elements 12′ is radially expansible relative to the axis of rotation X-X′ of the auxiliary drum 8 between a retracted position and an expanded position for turning up at least a part of each end portion 10 of said first belt layer 1 on said at least one second belt layer 2.

As shown in detail in FIG. 5, each of said pressing elements 12′ comprises a plurality of contact elements 14, placed along a circumference concentric to the axis of rotation X-X′ of the auxiliary turning up drum 8. Each contact element 14 is telescopically sliding circumferentially relative to the adjacent contact element 14.

According to an alternative embodiment not shown in the figures, each of said pressing elements 12′ comprises a plurality of contact elements 14, placed along a circumference concentric to the axis of rotation X-X′ of the auxiliary turning up drum 8, but connected to each other by a plurality of elastic devices.

According to preferred embodiments, the auxiliary turning up drum 8 comprises a shaping surface, preferably convex.

It is possible to provide that the first building drum 7 coincides with the second building drum 7′ or that they are drums of the same type or of different type.

The auxiliary turning up drum 8 may be geometrically different from the first building drum 7, if required and likewise, the same auxiliary turning up drum 8 may be geometrically different from the second building drum 7′, with the above advantages.

With reference now to FIG. 6, it is shown that the tyre building line 20 for vehicle wheels comprises:

at least one carcass structure building line 22, said carcass structure comprising at least one carcass ply and a pair of annular reinforcing structures;

at least one crown structure building line 21, said crown structure comprising a belt structure and a tread band.

According to the present invention, the crown structure building line 21 comprises at least one apparatus 3 for building tyres as described above.

With reference to the building apparatus 3 of the building plant 20, a preferred embodiment of a process for building tyres for vehicle wheels shall now be described, wherein each tyre comprises a carcass structure and a crown structure. The crown structure in turn comprises a belt structure including a first radially inner belt layer 1 and at least one second belt layer 2 radially external to the first belt layer 1.

According to a first step a), the process according to the invention provides placing an annular assembly 4, comprising a first radially inner belt layer 1 and at least one second radially outer belt layer 2, on at least one auxiliary turning up drum 8.

Afterwards, a step b) of defining at least one pair of folding lines 5 in axially opposite positions of said annular assembly 4 is carried out. Such step is carried out by respective abutment devices 6; 6′ which are radially external to said auxiliary turning up drum 8.

The building process also comprises a step c) of adjusting the axial position of said folding lines (5) relative to a centre line plane Y-Y′ of the auxiliary turning up drum 8.

Preferably, the process also comprises a step of adjusting the radial position of said abutment devices 6; 6′ relative to said auxiliary turning up drum 8, preferably according to the thickness and/or the diameter of said annular assembly 4.

Once the folding lines have been defined, the process provides, according to a step d), the turning up, at said folding lines 5, of at least a part of end portions 10 of the first belt layer 1 axially protruding relative to said at least one second belt layer 2 on said at least one second belt layer 2 of the annular assembly 4.

Such step d) may comprise the step of turning up at least a part of axially opposite end portions 10 of said first radially inner belt layer 1 on said second belt layer 2 and on a third belt layer (not shown in the figures) radially external to said second belt layer 2.

Such step d) may additionally comprise also the turning up of said second belt layer 2 on said third belt layer.

Preferably, said step d) of turning up is carried out substantially simultaneously to the rotation of the auxiliary turning up drum 8 about the axis of rotation X-X′ thereof.

According to a particularly preferred embodiment, step a) is preceded by a step f) of picking up the annular assembly 4 from at least one first building drum 7 and step d) is followed by a step e) of transferring the annular assembly 4 on a second building drum 7′.

An alternative embodiment provides, after step d), a step e′) of transferring the annular assembly 4 on said first building drum 7.

According to the first embodiment shown in FIGS. 1a and 1b, the adjustment of the axial position of said folding lines 5 comprises adjusting the axial position of at least one pair of contrast rollers 11 relative to the centre line plane Y-Y′ of the auxiliary turning up drum 8.

Preferably, at least one between the above steps f), a) and e) is carried out by at least one transfer device 9.

In this case it is possible to provide that the adjustment of the axial position of said folding lines comprises adjusting the axial position of at least one pair of contrast elements 15 of said transfer device 9 relative to the centre line plane Y-Y′ of the auxiliary turning up drum 8, as shown in the second embodiment illustrated in FIG. 2.

According to preferred embodiments, the tyre building process comprises the step g) of adjusting the diameter of the auxiliary turning up drum 8. Such step g) is carried out before step a) of placing the annular assembly 4 on the auxiliary turning up drum 8 and/or before step e) of transferring the annular assembly 4 on the second building drum 7′, or optionally before step e′).

In that case, advantageously, the two ends of said auxiliary turning up drum 8 correspond to the folding lines of the belt layer(s) to be turned up.

The process further comprises the step g1) of adjusting the width of said auxiliary turning up drum 8. As mentioned before, the term “width of the auxiliary drum” indicates the dimension that extends along the entire axis of rotation X-X′ thereof.

When provided, said step g1) is carried out before step a) of placing the annular assembly 4 on the auxiliary turning up drum 8 and/or before step e) of transferring the annular assembly 4 on the second building drum 7′, or optionally before step e′).

Preferably, step a) of placing the annular assembly 4 on at least one auxiliary turning up drum 8 and/or step e) of transferring the annular assembly 4 on the second building drum 7′ is followed by a step of shaping the belt structure.

FIGS. 1a and 1b show how each folding line 5 is defined in axially outer position relative to the axial end of the radially outermost belt layer, however such folding line 5 may be defined substantially at the axial end of the radially outermost axial end.

In fact, the process of the present invention allows to fold ends 10 where desired, as mentioned before.

According to the second embodiment shown in FIG. 2, the step d) of turning up is substantially carried out simultaneously along the entire circumferential extension of each folding line 5 and is carried out by at least one turning up device.

In that case, said step d) of turning up comprises the step of adjusting the axial position of said turning up device relative to the auxiliary turning up drum 8 and optionally adjusting the radial position of said turning up device relative to the auxiliary drum 8, preferably according to the thickness and/or the diameter of the annular assembly 4.

Preferably, the turning up device comprises at least one pair of turning up rollers 12, each turning up roller 12 being adapted for being rotated about each folding line 5 so as to turn up at least one part of each end portion 10 of said first belt layer 1 on said at least one second belt layer 2 of the belt structure.

As an alternative, the turning up device comprises at least one pair of pressing elements 12′ circumferentially placed at axially opposite parts of the auxiliary turning up drum 8.

With particular reference to FIGS. 3a-3m, the tyre building process in steady operation conditions according to a preferred embodiment of the invention shall now be described.

FIG. 3a shows an annular assembly 4 built on a first building drum 7, before step f) of picking up said annular assembly 4 from said drum.

FIG. 3b shows how the transfer devices 9 are radially adjusted up to contact the annular assembly 4, thus starting step f).

The subsequent removal of the first building drum 7 shown in FIG. 3c, starts the step a) of placing the annular assembly 4 on the auxiliary drum 8. In fact, during this step, the annular assembly 4 is separated from the building drum 7 and retained by the transfer devices 9, to be then transferred to the auxiliary drum 8 during the sequential steps shown in FIGS. 3d and 3e.

FIG. 3d shows how the transfer devices 9, whereto the annular assembly 4 is associated, shift in the direction indicated by the arrow to place at the auxiliary drum 8. In this position, the annular assembly contacts such auxiliary drum 8 and is separated from the transfer devices by shifting of the same towards the starting position thereof (FIG. 3e).

Preferably, the pick up of the annular assembly 4 by the auxiliary turning up drum 8 takes place by the radial expansion of the sectors of said auxiliary drum 8.

At this point, the step a) of placing the annular assembly 4 on the auxiliary drum 8 is completed.

Afterwards, steps b), c) and d) are carried out. The latter is schematically shown in FIG. 3f by the arrows.

In order to better illustrate such two steps, reference must be made to FIGS. 1a and 1b.

In particular, FIG. 1a shows how the abutment devices 6, after being suitably adjusted, define the folding lines 5, along which ends 10 of the first belt layer 1 will be folded on the second belt layer 2, by means of the turning up rollers 12.

The latter are adjusted radially and axially, as shown by arrow L, and then rotated in the direction indicated by arrow M, for carrying out the step d) of turning up. FIG. 1b shows that while ends 10 are folded by the turning up rollers 12, the abutment devices 6 are retracted so as to leave ends 10 of the first belt layer 1 to overlap at least partly the second belt layer 2 and the turning up operation is completed.

In FIG. 3g, the step e) of transferring the annular assembly 4 on a second building drum 7′ starts. In such figure, in fact, it is shown how the transfer devices 9 shift at the auxiliary drum 8 and are radially adjusted until they contact the annular assembly 4 with the turned up ends.

FIG. 3h shows how the transfer devices 9 pick up the annular assembly 4 from the auxiliary drum 8 and shift towards the initial position thereof.

In FIG. 3i, a second building drum 7′, preferably geometrically different from the first building drum 7, is placed at the transfer devices 9.

In FIG. 3l, the transfer devices 9 whereto the annular assembly 4 is associated, are radially adjusted up to contact the second building drum 7′. As an alternative, by the radial expansion of the sectors of the second building drum 7′ the pick up of the annular assembly 4 by the same building drum 7′ is allowed.

In FIG. 3m, the transfer devices 9 radially move away from the second auxiliary drum 7′ unloading the annular assembly 4 thereon and thus completing step e).

1-52. (canceled)

53. A process for building a tyre for a vehicle wheel wherein each tyre comprises a carcass structure and a crown structure, said crown structure comprising a belt structure comprising a first radially inner belt layer and at least one second belt layer radially external to the first belt layer, comprising:
a) placing an annular assembly comprising a first radially inner belt layer and at least one second radially outer belt layer on at least one auxiliary turning up drum;
b) defining at least one pair of folding lines in axially opposite positions of said annular assembly by respective abutment devices radially external to said auxiliary turning up drum;
c) adjusting an axial position of said folding lines relative to a centre line plane of the auxiliary turning up drum; and
d) turning up, at said folding lines, at least a part of end portions of said first belt layer axially protruding relative to said at least one second belt layer on said at least one second belt layer of said annular assembly.

54. The process for building a tyre according to claim 53, wherein a) is preceded by:
f) picking up said annular assembly from at least one first building drum.

55. The process for building a tyre according to claim 54, wherein d) is followed by:
e) transferring the annular assembly on a second building drum.

56. The process for building a tyre according to claim 54, wherein d) is followed by:
e′) transferring the annular assembly on said first building drum.

57. The process for building a tyre according to claim 53, further comprising adjusting a radial position of said abutment devices relative to said auxiliary turning up drum.

58. The process for building a tyre according to claim 53, wherein adjusting the axial position of said folding lines comprises adjusting an axial position of at least one pair of contrast rollers relative to a centre line plane of the auxiliary turning up drum.

59. The process for building a tyre according to claim 53, wherein d) turning up at least part of the end portions of said first belt layer is carried out substantially simultaneously to rotation of the auxiliary turning up drum about an axis of rotation thereof.

60. The process for a building tyre according to claim 55, wherein at least one of f), a) and e) is carried out by at least one transfer device.

61. The process for building a tyre according to claim 60, wherein adjustment of the axial position of the folding lines comprises adjusting an axial position of at least one pair of contrast elements of said transfer device relative to a centre line plane of the auxiliary turning up drum.

62. The process for building a tyre according to claim 53, wherein d) turning up at least part of the end portions of said first belt layer comprises turning up at least a part of axially opposite end portions of said first radially inner belt layer on said second belt layer and on a third belt layer radially external to said second belt layer.

63. The process for building a tyre according to claim 53, further comprising:
g) adjusting a diameter of said auxiliary turning up drum.

64. The process for building a tyre according to claim 63, wherein g) is carried out before placing said annular assembly on at least said auxiliary turning up drum.

65. The process for building a tyre according to claim 53, further comprising:
g1) adjusting the width of said auxiliary turning up drum.

66. The process for building a tyre according to claim 65, wherein g1) is carried out before placing said annular assembly on said at least one auxiliary turning up drum.

67. The process for building a tyre according to claim 63, wherein d) is followed by:
e) transferring the annular assembly on a second building drum, and wherein g) is carried out before transferring the annular assembly on said second building drum.

68. The process for building a tyre according to claim 63, wherein d) is followed by:
e′) transferring the annular assembly on said first building drum, and wherein g) is carried out before transferring the annular assembly on the first building drum.

69. The process for building a tyre according to claim 65, wherein d) is followed by:
e) transferring the annular assembly on a second building drum, and wherein g1) is carried out before transferring the annular assembly on a second building drum.

70. The process for building a tyre according to claim 65, wherein d) is followed by:
e′) transferring the annular assembly on said first building drum, and wherein g1) is carried out before transferring the annular assembly on the first building drum.

71. The process for building a tyre according to claim 55, wherein at least one of a) placing the annular assembly on at least one auxiliary turning up drum and e) transferring the annular assembly on a second building drum is followed by a step of shaping the belt structure.

72. The process for building a tyre according to claim 56, wherein at least one of a) placing the annular assembly on at least one auxiliary turning up drum and e′) transferring the annular assembly on the first building drum is followed by shaping the belt structure.

73. The process for building a tyre according to claim 53, wherein each folding line is substantially defined at an axial end of a radially outermost belt layer.

74. The process for building a tyre according to claim 53, wherein each folding line is defined in a position axially external to an axial end of a radially outermost belt layer.

75. The process for building a tyre according to claim 53, wherein turning up at least a part of end portions of said first belt layer is carried out substantially simultaneously along an entire circumferential extension of each folding line.

76. The process for building a tyre according to claim 53, wherein turning up at least a part of said portions of said first belt layer is carried out by at least one turning up device.

77. The process for building a tyre according to claim 76, wherein turning up of at least a part of end portions of said first belt layer comprises adjusting the axial position of said turning up device relative to said auxiliary turning up drum.

78. The process for building a tyre according to claim 76, wherein turning up at least a part of end portions of said first belt layer comprises adjusting a radial position of said turning up device relative to said auxiliary turning up drum.

79. The process for building a tyre according to claim 76, wherein said turning up device comprises at least one pair of turning up rollers, each turning up roller capable of being adapted for rotating about each folding line so as to turn up at least one part of each end portion of said first belt layer on said at least one second belt layer of the belt structure.

80. The process for building a tyre according to claim 76, wherein turning up at least a part of end portions of said first belt layer is carried out substantially simultaneously along an entire circumferential extension of each folding line, and wherein said turning up device comprises at least one pair of pressing elements circumferentially placed at axially opposite parts of the auxiliary turning up drum.

81. An apparatus for building a tyre for vehicle wheels, said tyre comprising a carcass structure and a crown structure, said crown structure comprising a belt structure comprising a first radially inner belt layer and at least one second belt layer radially external to the first belt layer comprising:
at least one auxiliary turning up drum capable of being adapted for supporting an annular assembly, comprising a first radially inner belt layer and at least one second belt layer radially external to said first belt layer; and
a plurality of abutment devices, radially external to said auxiliary turning up drum capable of being adapted for defining at least one pair of folding lines in axially opposite positions of said annular assembly,
wherein said abutment devices are adjustable in axial direction relative to a centre line plane of the auxiliary turning up drum.

82. The apparatus according to claim 81, comprising at least one transfer device capable of being adapted for transferring said annular assembly from a building drum to said at least one auxiliary turning up drum and vice versa.

83. The apparatus according to claim 81, wherein said abutment devices are adjustable in radial direction relative to the auxiliary turning up drum.

84. The apparatus according to claim 81, wherein said abutment devices comprise at least one pair of contrast rollers.

85. The apparatus according to claim 84, comprising at least one transfer device capable of being adapted for transferring said annular assembly from a building drum to said at least one auxiliary turning up drum and vice versa, wherein said abutment devices comprise at least one pair of contrast rollers of said transfer device.

86. The apparatus according to claim 82, comprising at least one transfer device capable of being adapted for transferring said annular assembly from a building drum to said at least one auxiliary turning up drum and vice versa, wherein the transfer device is adjustable in radial direction relative to the auxiliary turning up drum.

87. The apparatus according to claim 85, wherein the contrast elements of the transfer device are adjustable in axial direction relative to the centre line plane of the auxiliary turning up drum.

88. The apparatus according to claim 81, wherein the auxiliary turning up drum has an adjustable diameter.

89. The apparatus according to claim 81, wherein the auxiliary turning up drum has an adjustable width.

90. The apparatus according to claim 81, further comprising a turning up device adjustable in axial direction relative to said auxiliary turning up drum.

91. The apparatus according to claim 81, further comprising a turning up device adjustable in radial direction relative to said auxiliary turning up drum.

92. The apparatus according to claim 90, wherein said turning up device comprises at least one pair of turning up rollers, each turning up roller capable of being adapted for rotation about each folding line so as to turn up at least a part of each end portion of said first belt layer on said at least one second belt layer.

93. The apparatus according to claim 92, wherein each turning up roller comprises a barrel roller driven in rotation by pushing devices.

94. The apparatus according to claim 90, wherein said turning up device comprises at least one pair of pressing elements circumferentially placed at axially opposite parts of the auxiliary turning up drum.

95. The apparatus according to claim 94, wherein each of said pressing elements is radially expansible relative to the axis of rotation of the auxiliary drum between a retracted position and an expanded position for turning up at least one part of each end portion of said first belt layer on said at least one second belt layer.

96. The apparatus according to claim 95, wherein each of said pressing elements comprises a plurality of contact elements placed along a circumference concentric to the axis of rotation of the auxiliary turning up drum, each contact element being telescopically sliding circumferentially relative to adjacent contact element.

97. The apparatus according to claim 94, wherein each of said pressing elements comprises a plurality of contact elements placed along a circumference concentric to the axis of rotation of the auxiliary turning up drum and connected by a plurality of elastic devices.

98. The apparatus according to claim 81, wherein said auxiliary turning up drum comprises a shaping surface.

99. The apparatus according to claim 98, wherein said shaping surface comprises a convex surface.

100. The apparatus according to claim 82, wherein said transfer devices comprise a plurality of sectors.

101. The apparatus according to claim 82, wherein a first building drum coincides with a second building drum.

102. The apparatus according to claim 82, wherein said auxiliary turning up drum is geometrically different from a first building drum.

103. The apparatus according to claim 82, wherein said auxiliary turning up drum is geometrically different from a second building drum.

104. A plant for building a tyre for a vehicle wheel comprising:
at least one carcass structure building line, said carcass structure comprising at least one carcass ply and a pair of annular anchoring structures; and
at least one crown structure building line, said crown structure comprising a belt structure and a tread band,
wherein the crown structure building line comprises at least one apparatus for building tyres according to claim 81.
